(19) United States
(12) Patent Application Publication
(10) Pub. No.: US 2025/0214400 A1
(43) Pub. Date: Jul. 3, 2025

(54) FRONT SEAT SUNSHIELD

(71) Applicant: Bruce Bennett, Cincinnati, OH (US)

(72) Inventor: Bruce Bennett, Cincinnati, OH (US)

(21) Appl. No.: 18/849,587

(22) PCT Filed: Mar. 24, 2023
(86) PCT No.: PCT/US23/64906

§ 371 Date: Sep. 23, 2024

Related U.S. Application Data
(60) Provisional application No. 63/323,829, filed on Mar. 25, 2022.

(51) Int. Cl. B60J 3/02

(52) U.S. Cl. CPC B60J 3/0213

(57) ABSTRACT

A front seat sunshield is an accessory device that includes an elongate case positionable on a distal edge of a visor of a passenger vehicle. An engagement mechanism of the front seat sunshield is attached to the elongate case and is selectably engagable to the visor. One or more telescoping extensions attached to the elongate case and selectably expandable outward from the elongate case to block glare proximate to the distal edge of the visor.

### CROSS-REFERENCE TO RELATED APPLICATIONS

The present Application for Patent claims priority to U.S. Provisional Application No. 63/055,571 entitled “FRONT SEAT SUNSHIELD” filed Mar. 25, 2022, which is hereby expressly incorporated by reference herein.

### BACKGROUND

### 1. Technical Field

The present disclosure relates in general to passenger vehicle sunshields and more particularly to visor-mounted sunshields.

### 2. Description of the Related Art

Sunglare or glare from artificial lights is a serious problem that blocks or impairs vision of people sitting in the front seat of covered vehicles, especially drivers. Passenger vehicles typically include a visor that can be flipped down to provide a sunshield for an upper right or upper left side of windshield. Often the visor is rotatable to perform a similar function for the side window. The visor is spaced away from the rear view mirror so that the visor cannot be positioned such that the rear view mirror is obscured. Although the visor provides blocking glare and direct sunlight from a significant number of directions, the visor is inadequate in certain instances. Spaces around the rear view mirror allow for sunlight to distract the driver or passenger.

### BRIEF SUMMARY

In accordance with the teachings of the present disclosure, a front seat sunshield is an accessory device that includes an elongate case positionable on a distal edge of a visor of a passenger vehicle. An engagement mechanism of the front seat sunshield is attached to the elongate case and is selectably engagable to the visor. One or more telescoping extensions attached to the elongate case and selectably expandable outward from the elongate case to block glare proximate to the distal edge of the visor.

According to one aspect, an augmented vehicle visor includes a vehicle visor mountable on a proximal edge inside of passenger area of a vehicle proximate to an interior surface of a windshield. The vehicle visor has a recess along a distal edge. A sunshield device of the augmented vehicle visor is at least partially received in the recess along the distal edge. An elongate case of the sunshield device is positionable from the distal recess. One or more telescoping extensions are attached to the elongate case and selectably expandable outward from the elongate case to block glare proximate to the distal recess of the vehicle visor.

The above presents a general summary of several aspects of the disclosure in order to provide a basic understanding of at least some aspects of the disclosure. The above summary contains simplifications, generalizations and omissions of detail and is not intended as a comprehensive description of the claimed subject matter but, rather, is intended to provide a brief overview of some of the functionality associated therewith. The summary is not intended to delineate the scope of the claims, and the summary merely presents some concepts of the disclosure in a general form as a prelude to the more detailed description that follows. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 is a perspective interior view from a right rear orientation illustrating front seat sunshields attached to inward, distal edges of driver and passenger visors of a passenger vehicle, according to one or more embodiments;

FIG. 2 is a perspective interior view from a right side orientation illustrating the front seat sunshield on driver visor that is rotated over left side window of the passenger vehicle, according to one or more embodiments;

FIG. 3 is a perspective interior view from a right rear orientation illustrating front seat augmented vehicle visors that incorporate built-in sunshield devices, according to one or more embodiments;

FIG. 4 is a perspective interior view from a right side orientation illustrating the front driver augmented vehicle visor that is rotated over left side window of the passenger vehicle, according to one or more embodiments;

FIG. 5 is a top view illustrating the front seat sunshield both disengaged from and engaged to a distal edge of the driver visor, according to one or more embodiments;

FIG. 6 is a side view of the front seat sunshield, according to one or more embodiments;

FIG. 7 is a front view of the front seat sunshield with upper, middle, and lower extensions fully retracted, according to one or more embodiments;

FIG. 8 is a front view of the front seat sunshield with the upper extension in an extended position and the middle and lower extensions fully retracted, according to one or more embodiments;

FIG. 9 is a perspective view of accordian zigzag folded material of the upper, middle, and lower extensions, according to one or more embodiments;

FIG. 10 is a front view of the front seat sunshield with the middle extension in an extended position and the upper and lower extensions fully retracted, according to one or more embodiments;

FIG. 11 is a front view of the front seat sunshield with the upper and middle extensions in an extended position and the lower extension fully retracted, according to one or more embodiments;

FIG. 12 is a front view of the front seat sunshield with the upper and middle extensions fully retracted and the lower extension in an extended position, according to one or more embodiments;

FIG. 13 is a front view of the front seat sunshield with the upper, middle and lower extensions in an extended position, according to one or more embodiments;

FIG. 14 is a front view of a twin antenna example extension in a retracted position, according to one or more embodiments;

FIG. 15 is a side view of the twin antenna example extension in the retracted position, according to one or more embodiments;

FIG. 16 is a front view of the twin antenna example extension in an extended position, according to one or more embodiments;

FIG. 17 is a side view of the twin antenna example extension in the extended position, according to one or more embodiments;

FIG. 18 is a side view of a disassembled example fully retractable extension with a conceiling cover, according to one or more embodiments;

FIG. 19 is a side view of the example fully retractable extension of FIG. 18 fully retracted within the cover, according to one or more embodiments;

FIG. 20 is a side view of the example fully retractable extension of FIG. 18 fully full extended out of the cover, according to one or more embodiments;

FIG. 21 is an isometric view of a slotted plate of an example stacked slotted plate extension, according to one or more embodiments;

FIG. 22 is an isometric view of four slotted plates of the example stacked slotted plate extension in a retracted position, according to one or more embodiments;

FIG. 23 is an isometric view of the four slotted plates of the example stacked slotted plate extension in an extended position, according to one or more embodiments;

FIG. 24 is an isometric view of a flanged slotted plate of an example stacked flange slotted plate extension, according to one or more embodiments;

FIG. 25 is an isometric view of four slotted plates of the example stacked flange slotted plate extension in a retracted position, according to one or more embodiments;

FIG. 26 is an isometric view of the four flange slotted plates of the example stacked flange slotted plate extension in an extended position, according to one or more embodiments;

FIG. 27 is an isometric view of two disassembled rectangular telescoping components of an example rectangular telescoping extension, according to one or more embodiments;

FIG. 28 is an isometric view of the two nested rectangular telescoping components of the example rectangular telescoping extension in a retracted position, according to one or more embodiments; and

FIG. 29 is an isometric view of the two nesting rectangular telescoping components plates of the example rectangular telescoping extension in an extended position, according to one or more embodiments.

### DETAILED DESCRIPTION

According to the present disclosure, a front seat sunshield is an accessory device that includes an elongate case positionable on a distal edge of a visor of a passenger vehicle. An engagement mechanism of the front seat sunshield is attached to the elongate case and is selectably engagable to the visor. One or more telescoping extensions attached to the elongate case and selectably expandable outward from the elongate case to block glare proximate to the distal edge of the visor.

In one or more embodiments, Front Seat SunShield or (FS3) is a device used as an aid to block the sun, sun glare or light glare in the front seats of vehicles. It is a plastic device that is attached to the front seat sun visor and blocks glare in the front windshield as well as the side windows. The device is small, compactible, and can be easily attached and removed from the front seat sun visors of all vehicles.

Sun glare or glare from lights is a serious problem that blocks or impairs vision for people sitting in the front seat of covered vehicles, especially drivers. This device gives people sitting in either front seat the ability to block the glare by moving components of the device in the direct path of the glare to eliminate any irritation or vision impairment of the glare.

The front seat sunshield is easily clasped to the end of the vehicle's visor and is just as easily removed. Most importantly, it has two (2) components that are one inch vertically that can be pulled out up to 6 inches horizontally that allows front seat occupants to completely block out any glare coming above any rearview mirror. This gives the occupants the ability to control whether glare is completely or partially blocked. A third component also gives additional glare blockage with 2 inches of vertical and 6 inches of additional glare blockage which is especially useful with side window glare. No other device allows the occupant to have the option and control to block out any or all glare coming into the front windshield or side mirrors.

The front seat sunshield is easily clasped to the end of the visor with a plastic clothes pin type clasp and, using an according folding method, can be moved by the occupant to block any glare, including glare above the rearview mirror. Used to the maximum capacity, in addition to the car visor, it gives additional blockage of up to 4 inches vertically and 6 inches horizontally. And it gives the occupant the option to choose any combination of glare blockage. No other products offer this.

Everything about the front seat sunshield is unique. The occupant has total control over how much glare he/she is exposed to. In one or more embodiments, being able to pull the first level out covering 1 inch vertically and up to 6 inches horizontally to block glare above the rearview mirror is unique. The second level allows another 1 inch vertical blockage and, like level 1 and 3, up to 6 inches in horizontal blockage. This gives additional blockage for some vehicles, including sports utility vehicles (SUVs), with 2 inches above the rearview mirror below the top edge of the windshield. The third level is 2 inches of vertical and up to 6 inches of horizontal glare blockage. The occupant has complete control of the length of each level and can pull outward for maximum or desired glare blockage. There is no other product on the market that gives complete glare blockage, therefore reducing or completing eliminating driving vision impairment. In addition, the device is easily attached and removed with a simple clasp. This attachment does not block the mirrors or lights on the manufacturer's vehicle visor. There is no unsightliness-with this attachment.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

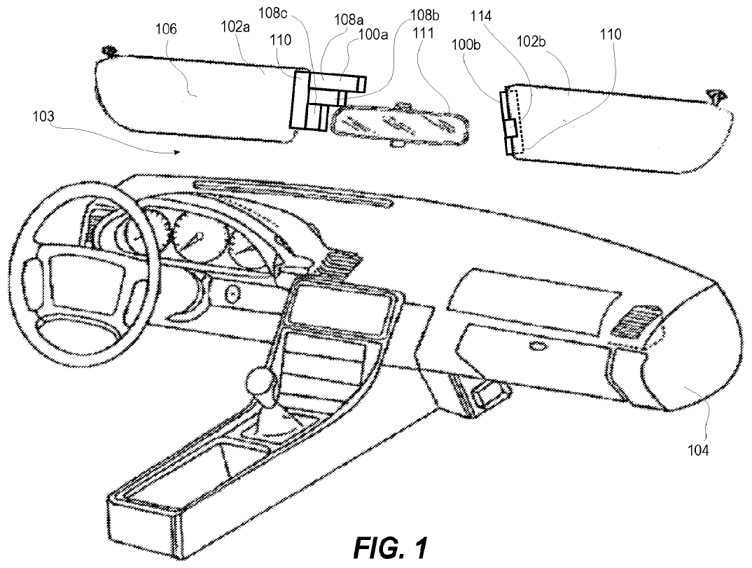

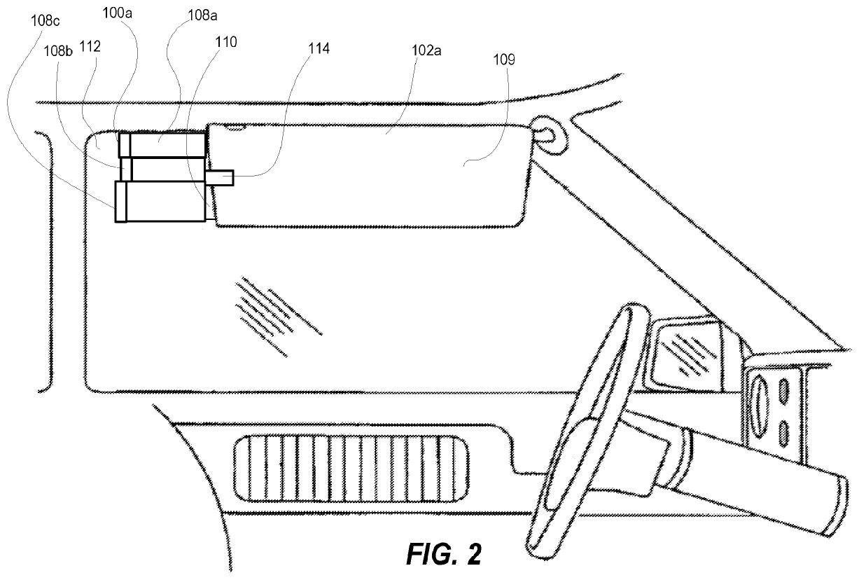

FIG. 1 illustrates left and right front seat sunshields 100a, 100b that are engaged respectively to inward, distal edges of driver and passenger visors 102a, 102b shielding glare from windshield 103 of a passenger vehicle 104. Left sunshield 100a is engaged to a backside 106 of driver visor 102a by lever clasp 114 (FIG. 2), exposing upper, middle and lower extensions 108a-108c attached to an elongate case 110 of front seat sunshield 100a. Upper, middle and lower extensions 108a-108c are adjustable to an amount to block glare around a rearview mirror 111. Right sunshield 100b is engaged to a frontside 109 of driver visor 102a, hiding upper, middle and lower extensions 108a-108c that attached to an elongate case 110 of front seat sunshield 100b. FIG. 2 illustrates front seat sunshield 100a on driver visor 102a that is rotated over left side window 112 of passenger vehicle 104.

In one or more embodiments, dimensions of left and right front seat sunshields 100a, 100b are mirror image and customized for a particular lateral side of the passenger vehicle 104. For example, upper and middle extensions 108a-108b can be 1 inch high and extendable to 6 inches. Lower extension 108c can be 2 inches high and extendable to 6 inches. In one or more embodiments left and right front seat sunshields (not shown) are identical with symmetric dimension of one or more extensions and usable on either lateral side of the passenger vehicle 104. For example, two, three, four or more extensions can be of the same vertical height, such as 1 inch or be ordered such the heights are in same pattern whether oriented with extensions to the right or to the left.

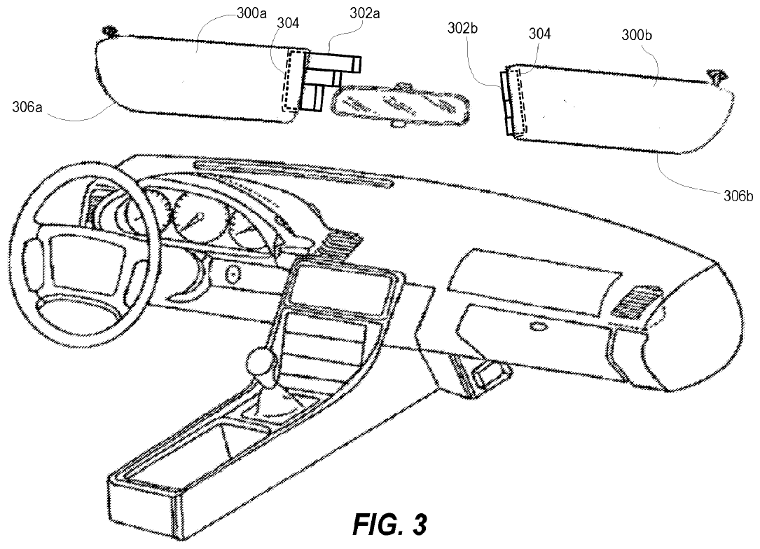

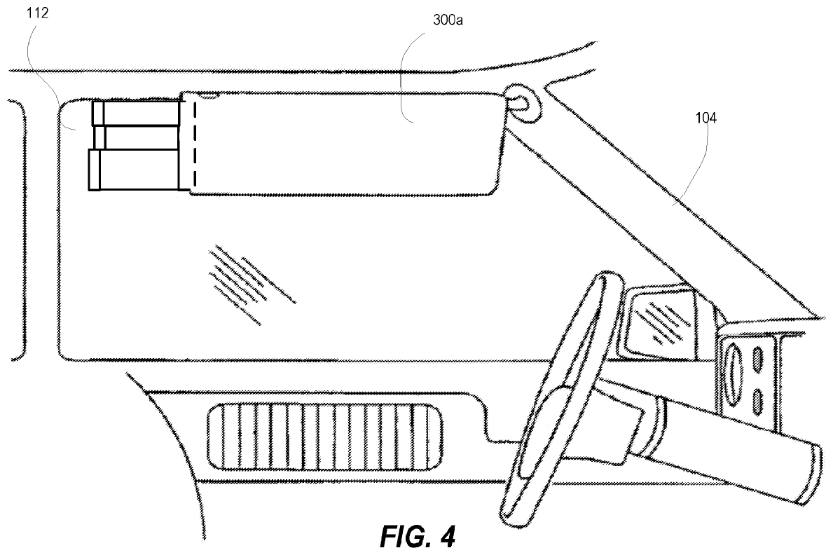

FIG. 3 depicts front seat augmented vehicle visor 300a-300b that incorporate built-in sunshield devices 302a-300b within respective distal recesses 304 formed in a distal edge of right and left vehicle visors 306a-306b. Sunshield devices 302a-300b can be identical to sunshields 100a, 100b sans clips 105. FIG. 4 depicts the driver augmented vehicle visor 300a that is rotated over the left side window 112 of the passenger vehicle 104.

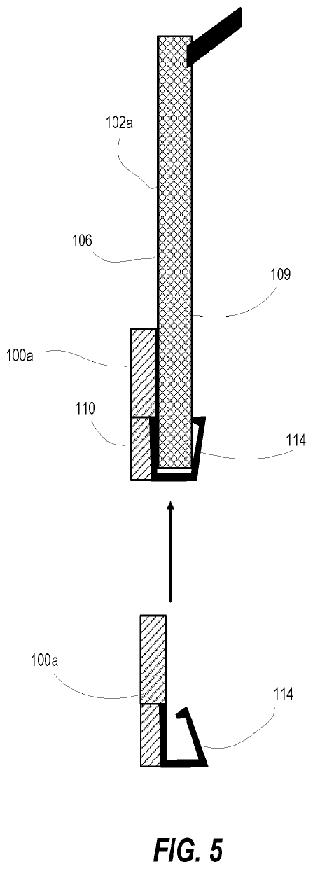

FIG. 5 illustrates front seat sunshield 102a both disengaged from and engaged by a lever clasp 114 to a distal edge of the driver visor 102a. Lever clasp 114 can be formed of a material that resilients seeks to close or be a hinged and spring-loaded clip.

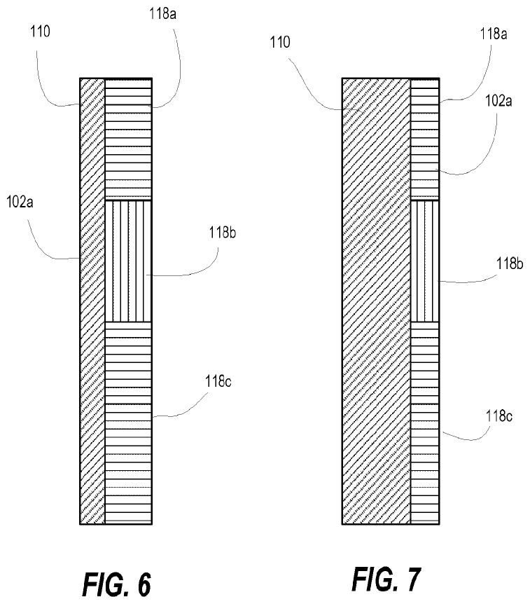

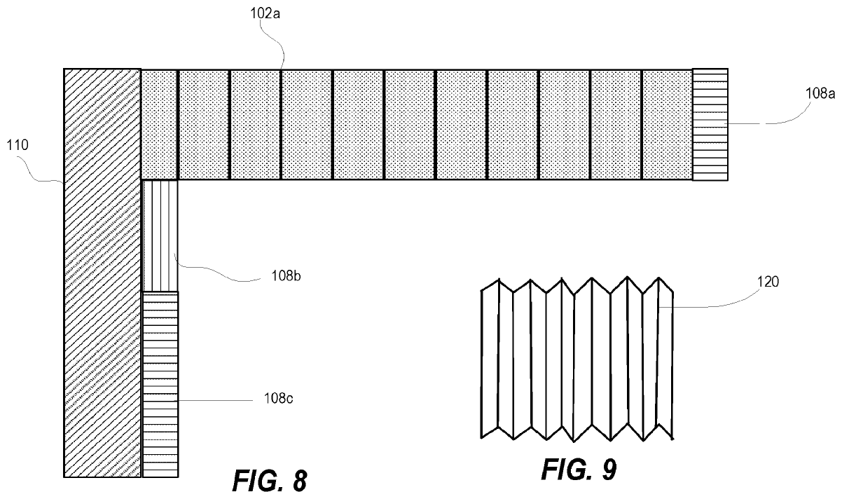

FIGS. 6-7 illustrate side and front views of front seat sunshield 102a as having elongate case 110 with graspable ends 118a-118c respectively of upper, middle and lower extensions 108a-108c that are fully retracted. FIG. 8is a front view of front seat sunshield 102a with upper extension 108a in an extended position and the middle and lower extensions 108b, 108c fully retracted. In one embodiment, FIG. 9 illustrates accordian zigzag folded material 120 of the upper, middle, and lower extensions 108a-108c can have sufficient rigidity to maintain a manually selected position of retracted, partially extended, or fully extended.

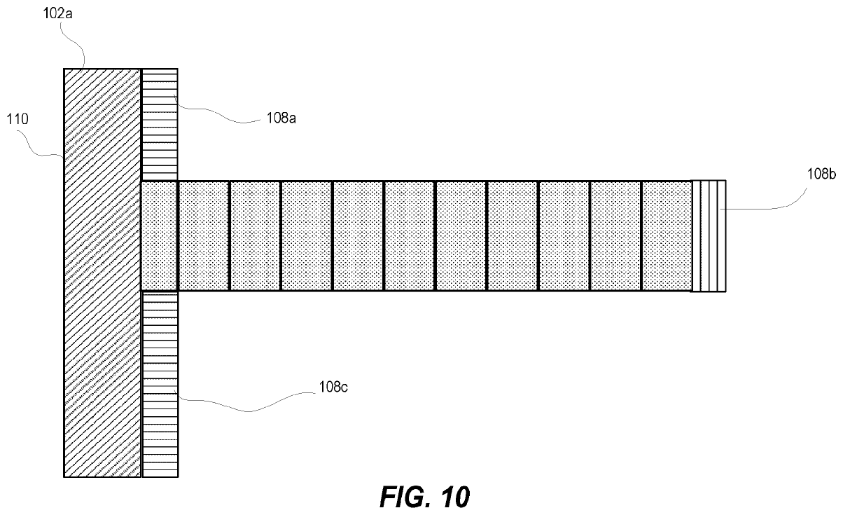

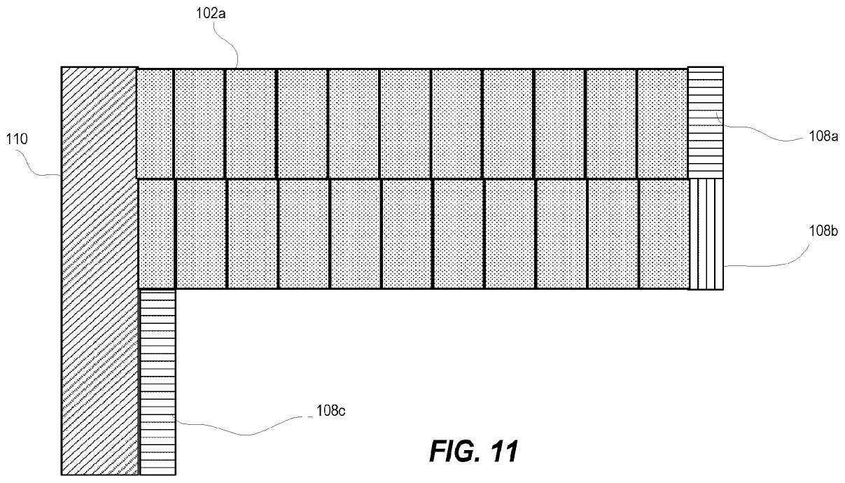

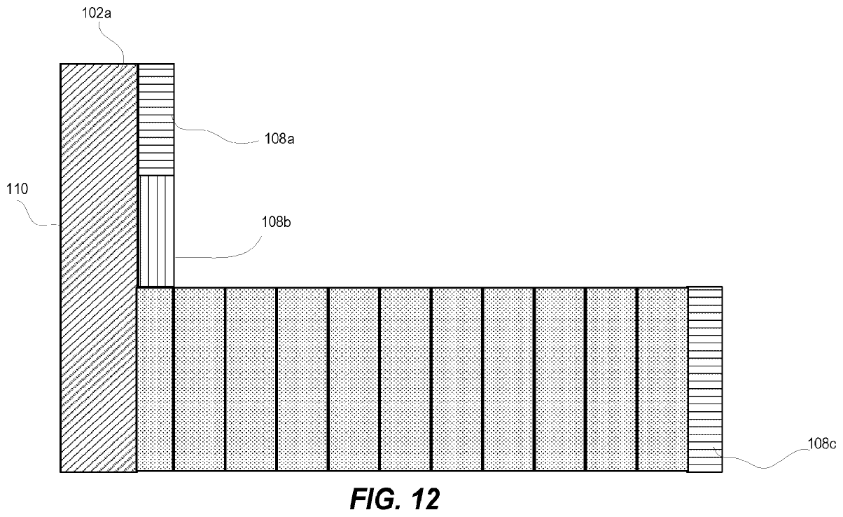

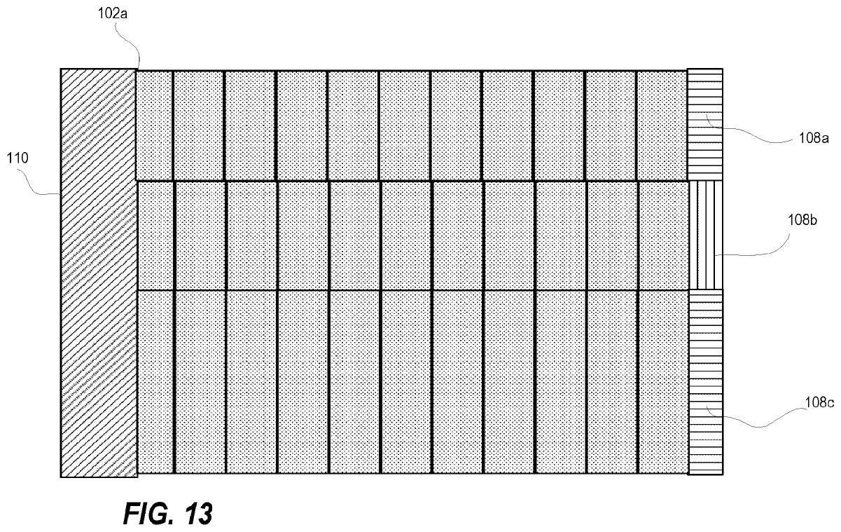

FIG. 10 is a front view of front seat sunshield 102a with the middle extension 108b in an extended position and the upper and lower extensions 108a, 108c fully retracted. FIG. 11 is a front view of the front seat sunshield 102a with the upper and middle extensions 108a-108b in an extended position and the lower extension 108c fully retracted. FIG. 12 is a front view of front seat sunshield 102a with the upper and middle extensions 108a-108b fully retracted and lower extension 108c in an extended position. FIG. 13 is a front view of front seat sunshield 102a with the upper, middle and lower extensions 108a-108c in an extended position.

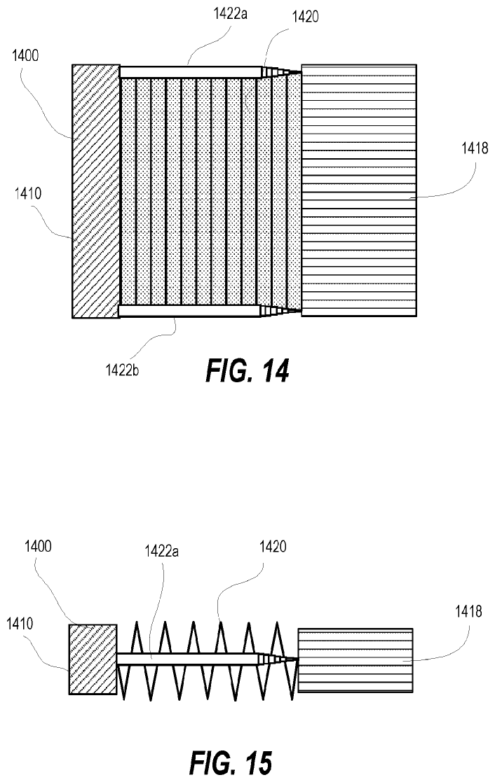

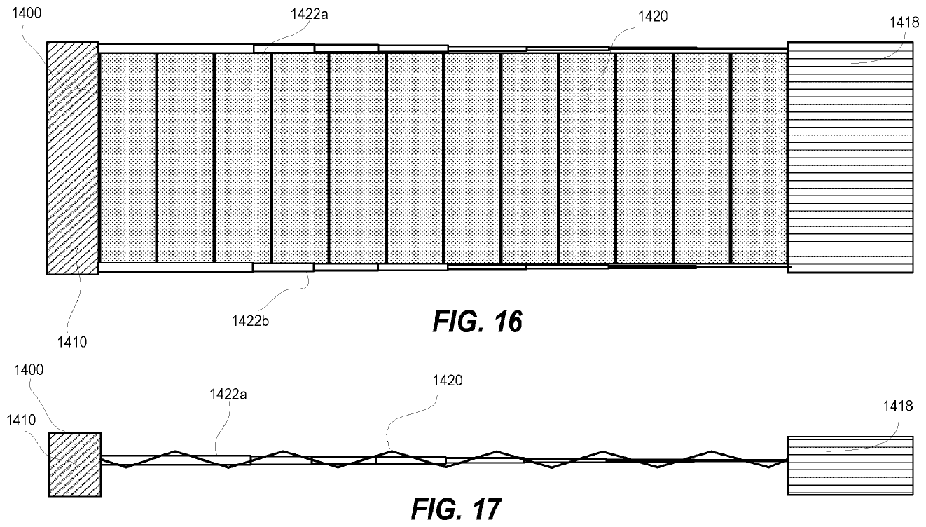

FIGS. 14-15 are front and side views of an alternative front seat sunshield 1400 having example extension 1408 that is in a retracted position. Accordian zigzag folded material 1420 is attached between plastic elongate case 1410 and graspable end 1418. Upper and lower positionable support is provided respectively by metal telescoping antenna supports 1422a, 1422b. FIGS. 16-17 are front and side views of alternative front seat sunshield 200 having example extension 208 that is in an extended position.

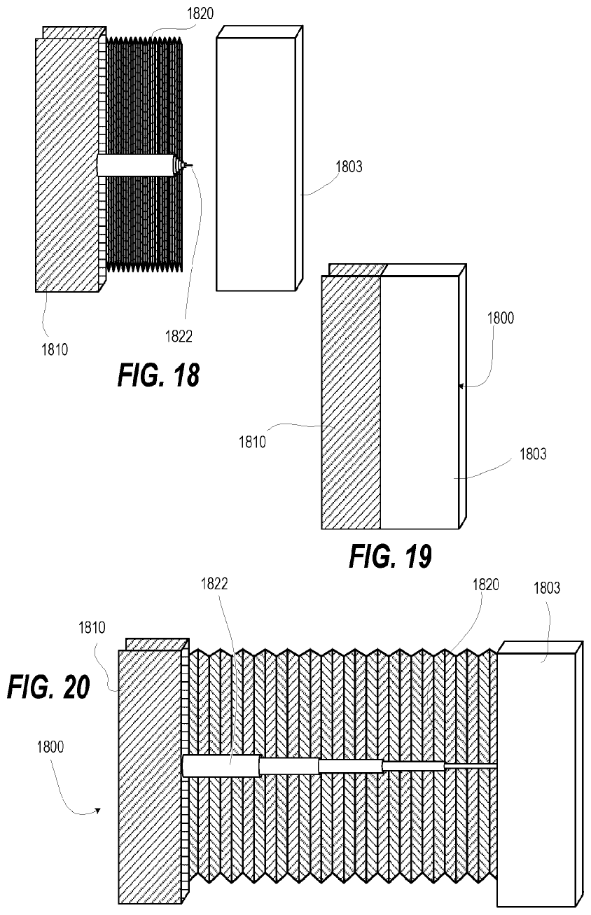

FIG. 18 depicts a disassembled example fully retractable extension 1800 with a conceiling cover 1803. An elongate case 1810 is attached to accordian zigzag folded material 1820. Upper and lower positionable support is provided respectively by metal telescoping antenna supports 1822a, 1822b. FIG. 19 depicts the example fully retractable extension 1800 fully retracted within the cover 1803. FIG. 20 depicts the example fully retractable extension 1800 fully extended out of the cover 1803.

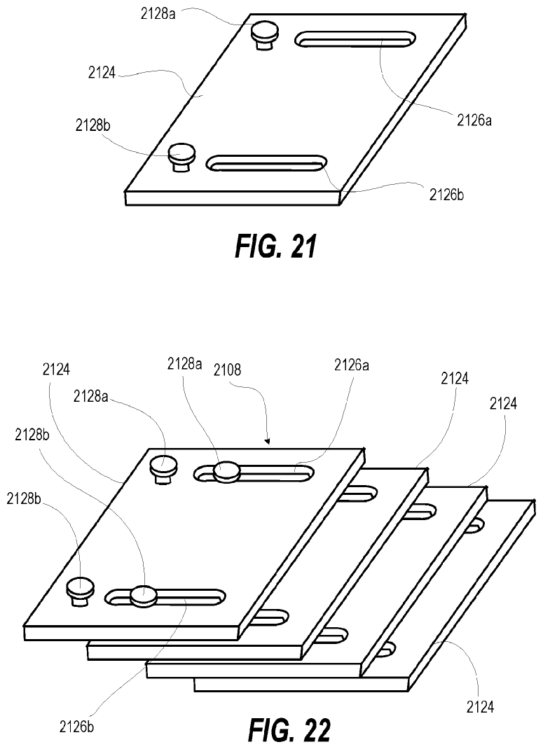

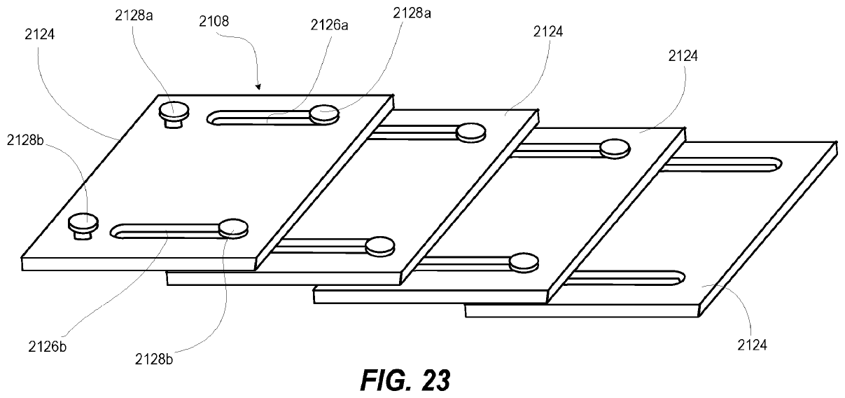

FIG. 21 illustrates an alternate slotted plate 2124 that is rectangular with two longitudinal and parallel slots 2126a, 2126b with proximal and aligned top and bottom headed pins 2128a, 2128b. FIG. 22 illustrates example stacked slotted plate extension 2108 of four slotted plates 2124 with adjacent slotted plates 2124 engaged in a retracted position by receiving top and bottom headed pins 2128a, 2128b from lower slotted plate 2124 through slots 2126a, 2126b. FIG. 23 illustrates example stacked slotted plate extension 2118 in an extended position.

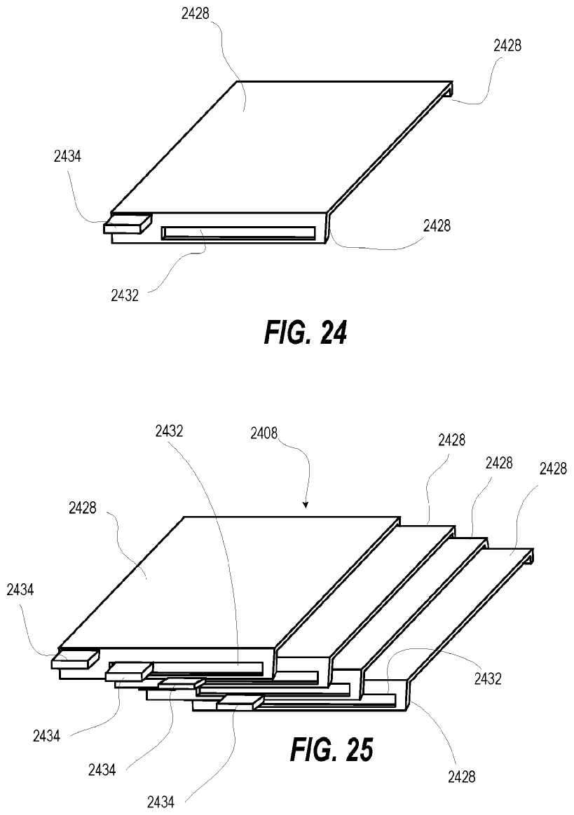

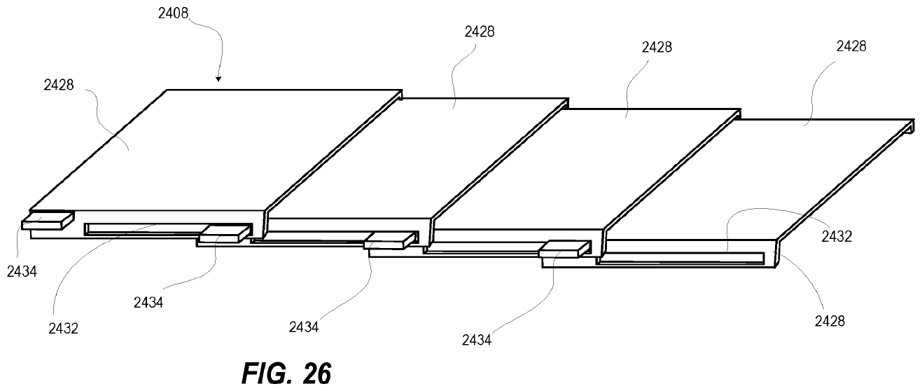

FIG. 24 illustrates flanged slotted plate 2428 that is rectangular with top and bottom forward flanges 2430 each having longitudinal slot 2432 and proximal and outward guide bar 2434. FIG. 25 is illustrates stacked flange slotted plate extension 2408 of four slotted plates 2428 in a stacked and retracted position. Adjacent flanged slotted plate 2428 are engaged by having guide bars 2434 of a lower adjacent flange slotted plate 2428 received for longitudinal movement in longitudinal slots 2432. FIG. 26 illustrates four flange slotted plates 2428 of example stacked flange slotted plate extension 2408 in an extended position.

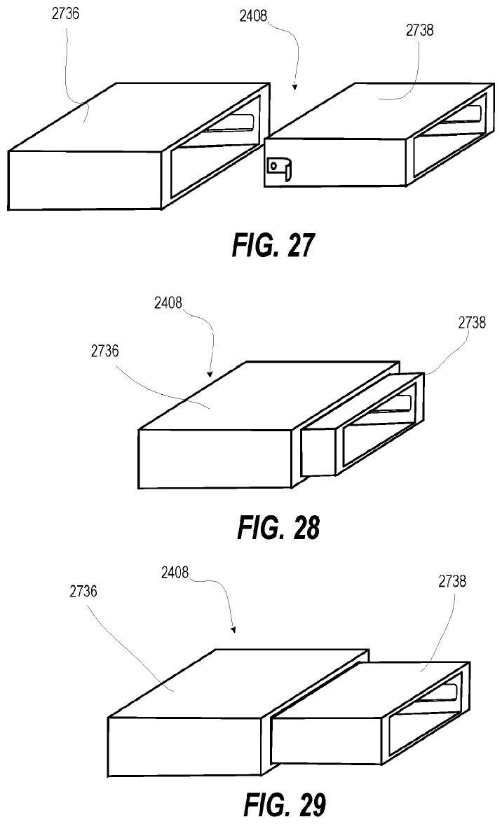

FIG. 27 illustrates two disassembled outer and inner rectangular telescoping components 2736, 2738 of example rectangular telescoping extension 2708. For clarity, two rectangular telescoping components 2736, 2738 are illustrates, although more could be included for greater extension. FIG. 28 illustrates two nested outer and inner rectangular telescoping components 2736, 2738 of example rectangular telescoping extension 2708 in a retracted position. FIG. 29 illustrates example rectangular telescoping extension 2708 in an extended position.

In further aspects, the elongate case 110 can comprise a plurality of securing or connecting means, such as, and without limitation, VELCRO at one portion and a clamping mechanism on another portion of the elongate case 110. In still further aspects, the device can comprise a securing means for releasably securing the auxiliary visor panel to the elongate case 110. In yet further aspects, the elongate case 110 can have a rectangular, arcuate, v-shaped, oval, round, or cylindrical shape.

In further aspects, the front seat sunshield can be comprised of an UV-reducing and/or glare-reducing material, or a combination thereof. In still further aspects, the front seat sunshield can be comprised of an opaque, micro-louver, transparent, tinted, translucent, polarized, phototropic, electrochromic, fabric, cloth, plastic, woven or non-woven, natural or synthetic material, or combinations thereof. In some aspects, the front seat sunshield can comprise a tinted acrylic panel.

In further aspects, the disclosed visor systems, and portions thereof, may be installed as OEM equipment in vehicles. For example, in some aspects, the elongate case 110 or case bracket may be present as an OEM vehicle part, and the front seat sunshield may be configured to be attached to the OEM part by inserting the sunshield into the pre-installed case.

In still further aspects, the front seat sunshield can comprise a triangular shape, and be configured to be secured to a corner of the vehicle visor. In yet further aspects, at least one securing means is configured to be secured to first portion of the vehicle visor, and at least one other securing means is configured to be secured to a second portion of the front seat sunshield. In even further aspects, the front seat sunshield further comprises a securing means configured to releasably secure a portion of the front seat sunshield to a portion of the visor.

In various aspects, the securing means comprises a clip, clamp, latch, bracket, snap, fitting, clasp, Velcro, strap, tie wraps, hook and latch, loop and tie, cable, elastic, band, button and buttonholes, or combinations thereof. In further aspects, the connecting means comprises a hinge or similar connecting mechanism. In further aspects, the components can be releasably connected. In a still further aspect, the connection can be achieved using a snap, friction fitting, snap ring, O-ring, pressure fitting, clip, clasp, and the like. The snap ring or O-ring can be retained within a groove to accommodate the snap ring or O-ring. In a further aspect, the system can comprise an engagement means for coupling and holding components together. In a further aspect, the engagement means can be a screwing mechanism, a click-lock mechanism, or friction mechanism, or the like. In other aspects, the connecting means can comprise a fitting, insert, adhesive, brazing, soldering, welding, spot weld, screw with nut, or rivet, or a combination thereof.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A sunshield accessory device comprising:
an elongate case positionable on a distal edge of a visor of a passenger vehicle;
an engagement mechanism attached to the elongate case and selectably engagable to the visor; and
one or more telescoping extensions attached to the elongate case and selectably expandable outward from the elongate case to block glare proximate to the distal edge of the visor.

2. The sunshield accessory device of claim 1, wherein the engagement mechanism comprises a spring-closed lever clasp.

3. The sunshield accessory device of claim 1, wherein the one or more telescoping extensions comprise an upper telescoping extension extendable above a portion of a rearview mirror of the passenger vehicle.

4. The sunshield accessory device of claim 3, wherein the one or more telescoping extensions further comprise a middle telescoping extension extendable above the portion of the rearview mirror of the passenger vehicle.

5. The sunshield accessory device of claim 1, wherein the one or more telescoping extensions comprise a lower telescoping extension extendable proximate to a lateral side of a rearview mirror of the passenger vehicle.

6. The sunshield accessory device of claim 1, wherein the one or more telescoping extension comprise:
an accordian zigzag folded material; and
upper and lower telescoping supports attached to elongate case and to respective upper and lower edges of the accordian zigzag folded material to support the accordian zigzag folded material in the selectable amount of extension.

7. The sunshield accessory device of claim 1, wherein the one or more telescoping extension comprise:
an accordian zigzag folded material; and
a telescoping support attached to elongate case and coupled to a distal end of the accordian zigzag folded material to support the accordian zigzag folded material in the selectable amount of extension.

8. The sunshield accessory device of claim 1, wherein the one or more telescoping extension comprise a plurality of sunblocking plates that are each engaged for longitudinal movement to an adjacent sunblocking plate between a substantially overlapping stacked position and a substantially juxtaposed extended position.

9. The sunshield accessory device of claim 1, further comprising a cover that is attached to a distal edge of the one or more telescoping extensions and encompasses the one or more telescoping extensions in a collapsed state.

10. An augmented vehicle visor comprising:
a vehicle visor mountable on a proximal edge inside of passenger area of a vehicle proximate to an interior surface of a windshield, the vehicle visor comprising a recess along a distal edge; and
a sunshield device at least partially received in the recess along the distal edge and comprising:
an elongate case positionable from the distal recess; and
one or more telescoping extensions attached to the elongate case and selectably expandable outward from the distal recess and extending out of the elongate case to block glare proximate to the distal edge of the vehicle visor.

11. The augmented vehicle visor of claim 10, wherein the one or more telescoping extensions comprise an upper telescoping extension extendable above a portion of a rearview mirror of the passenger vehicle.

12. The augmented vehicle visor of claim 10, wherein the one or more telescoping extensions further comprise a middle telescoping extension extendable above the portion of the rearview mirror of the passenger vehicle.

13. The augmented vehicle visor of claim 10, wherein the one or more telescoping extensions comprise a lower telescoping extension extendable proximate to a lateral side of a rearview mirror of the passenger vehicle.

14. The augmented vehicle visor of claim 10, wherein the one or more telescoping extension comprise:
an accordian zigzag folded material; and
upper and lower telescoping supports attached to elongate case and to respective upper and lower edges of the accordian zigzag folded material to support the accordian zigzag folded material in the selectable amount of extension.

15. The augmented vehicle visor of claim 10, wherein the one or more telescoping extension comprise:
an accordian zigzag folded material; and
a telescoping support attached to elongate case and coupled to a distal end of the accordian zigzag folded material to support the accordian zigzag folded material in the selectable amount of extension.

16. The augmented vehicle visor of claim 10, wherein the one or more telescoping extension comprise a plurality of sunblocking plates that are each engaged for longitudinal movement to an adjacent sunblocking plate between a substantially overlapping stacked position and a substantially juxtaposed extended position.

17. The augmented vehicle visor of claim 10, further comprising a cover that is attached to a distal edge of the one or more telescoping extensions and encompasses the one or more telescoping extensions in a collapsed state.
